(19) United States
(12) Patent Application Publication
(10) Pub. No.: US 2007/0028513 A1
(43) Pub. Date: Feb. 8, 2007

(54) Decorative covering for a potted plant

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 11/526,481

(22) Filed: Sep. 25, 2006

Related U.S. Application Data
(63) Continuation of application No. 10/423,497, filed on Apr. 24, 2003, now abandoned.
Application No. 10/423,497 is a continuation-in-part of application No. 09/954,665, filed on Sep. 18, 2001, now abandoned.
Application No. 09/954,665 is a continuation-in-part of application No. 09/612,122, filed on Jul. 7, 2000, now Pat. No. 6,385,904.
Application No. 09/612,122 is a continuation of application No. 09/466,705, filed on Dec. 17, 1999, now Pat. No. 6,105,311.
Application No. 09/466,705 is a continuation of application No. 09/062,329, filed on Apr. 17, 1998, now Pat. No. 6,061,959.
Application No. 09/062,329 is a continuation of application No. 08/749,626, filed on Nov. 18, 1996, now Pat. No. 5,829,194.
Application No. 08/749,626 is a continuation-in-part of application No. 08/458,327, filed on Jun. 2, 1995, now Pat. No. 5,575,133.
Application No. 08/458,327 is a continuation of application No. 08/386,859, filed on Feb. 10, 1995, now Pat. No. 5,493,809.

(51) Int. Cl. A01G 17/10

(52) U.S. Cl. 47/42

(57) ABSTRACT

A sleeve used to wrap items such as potted plants. The sleeve may have an open or closed bottom. When closed, the bottom may have a gusset for allowing expansion upon the depositing of the pot into the sleeve or a half-hexagonal portion for enabling concealed folds to be formed in the bottom. The sleeve may have a detachable upper portion. The sleeve may have a bonding material disposed upon an inner or outer portion of the sleeve for attaching the sleeve to the pot or item.

### CROSS REFERENCE TO RELATED APPLICATIONS

The present application is a continuation of U.S. Ser. No. 10/423,497, filed Apr. 24, 2003, now abandoned; which is a continuation-in-part of U.S. Ser. No. 09/954,665, filed Sep. 18, 2001, now abandoned; which is a continuation-in-part of U.S. Ser. No. 09/612,122, filed Jul. 7, 2000, now U.S. Pat. No. 6,385,904, issued May 14, 2002; which is a continuation of U.S. Ser. No. 09/466,705, filed on Dec. 17, 1999, now U.S. Pat. No. 6,105,311, issued Aug. 22, 2000; which is a continuation of U.S. Ser. No. 09/062,329, filed Apr. 17, 1998, now U.S. Pat. No. 6,061,959, issued May 16, 2000; which is a continuation of U.S. Ser. No. 08/749,626, filed Nov. 18, 1996, now U.S. Pat. No. 5,829,194, issued Nov. 3, 1998; which is a continuation-in-part of U.S. Ser. No. 08/458,327, filed Jun. 2, 1995, now U.S. Pat. No. 5,575,133, issued Nov. 19, 1996; which is a continuation of U.S. Ser. No. 08/386,859, filed Feb. 10, 1995, now U.S. Pat. No. 5,493,809. Each of the patent applications and patents listed herein is hereby expressly incorporated herein by reference.

### STATEMENT REGARDING FEDERALLY SPONSORED RESEARCH OR DEVELOPMENT

Not Applicable.

### FIELD OF INVENTION

This invention generally relates to sleeves, and more particularly, sleeves used to wrap flower pots containing floral groupings and/or mediums containing floral groupings, and methods of using same. U.S. Pat. No. 5,625,979, and U.S. Pat. No. 5,572,851, may contain subject matter related to the present application.

### BRIEF DESCRIPTION OF THE DRAWINGS

FIG. 1 is a side view of a sleeve having a detaching element and bonding material and constructed in accordance with the present invention.

FIG. 2A is a cross-sectional view taken along 2A-2A of the sleeve of FIG. 1.

FIG. 2B is a cross-sectional view taken along 2B-2B of the sleeve of FIG. 1.

FIG. 3 is an elevational view of an alternate version of a sleeve constructed in accordance with the present invention.

FIG. 4 is a cross-sectional view taken along line 4-4 of the sleeve of FIG. 3.

FIG. 5 is a cross-sectional view of another embodiment of a sleeve constructed in accordance with the present invention.

FIG. 6 is a cross-sectional view of another embodiment of a sleeve constructed in accordance with the present invention wherein areas of bonding material are disposed upon portions of both inner surfaces of the sleeve.

FIG. 7 is a cross-sectional view of another embodiment of a sleeve constructed in accordance with the present invention having a release material disposed between the two areas of bonding material.

FIG. 8 is a perspective view of the sleeve of FIG. 7.

FIG. 9 is a cross-sectional view of another embodiment of a sleeve constructed in accordance with the present invention wherein release material is disposed upon the areas of bonding material.

FIG. 10 is a cross-sectional view of another embodiment of a sleeve constructed in accordance with the present invention having staggered areas of bonding material on the inner surfaces.

FIG. 11 is a cross-sectional view of another embodiment of a sleeve constructed in accordance with the present invention wherein the bonding material is disposed upon a portion of the surface of the gusset facing the inner surface of the sleeve.

FIG. 12 is an elevational view of another embodiment of a sleeve constructed in accordance with the present invention.

FIG. 13 is a cross-sectional view taken along line 13-13 of the sleeve of FIG. 12.

FIG. 14 is a cross-sectional view of another embodiment of a sleeve constructed in accordance with the present invention having a release material disposed within the inner space thereof.

FIG. 15 is an elevational view of another embodiment of a sleeve constructed in accordance with the present invention wherein the bonding material has an alternate pattern.

FIG. 16A is an elevational view of another version of a sleeve constructed in accordance with the present invention wherein the sleeve has a closure bonding material disposed thereon.

FIG. 16B is a cross-sectional view taken along 16B-16B of the sleeve of FIG. 16A.

FIG. 17A is an elevational view of another embodiment of a sleeve constructed in accordance with the present invention having a closure bonding material disposed thereon.

FIG. 17B is a cross-sectional view taken along 17B-17B of the sleeve of FIG. 17A.

FIG. 17C is a cross-sectional view of another sleeve constructed in accordance with the present invention having a closure bonding material disposed on two areas of the sleeve.

FIG. 18 is an elevational view of another embodiment of a sleeve constructed in accordance with the present invention having an upper portion extending only slightly above the uppermost portion of the lower portion.

FIG. 19 is an elevational view of another sleeve constructed in accordance with the present invention having a bonding material on the inner surface thereof.

FIG. 20 is an elevational view of yet another embodiment of a sleeve constructed in accordance with the present invention.

FIG. 21 is a cross-sectional view taken along line 21-21 of the sleeve of FIG. 20.

FIG. 22 is an elevational view of an alternative embodiment of a sleeve constructed in accordance with the present invention.

FIG. 23 is an elevational view of another embodiment of a sleeve constructed in accordance with the present invention.

FIG. 24 is an elevational view of the sleeve of FIG. 23 having a pot disposed therein.

FIG. 25 is an elevational view of the pot and sleeve of FIG. 24 rotated 900 in a counter-clockwise direction.

FIG. 26A is a bottom plan view of the opened sleeve of FIG. 24.

FIG. 26B is a bottom plan view of the opened sleeve of FIG. 24 wherein the bottom is folded in an alternative configuration compared to the bottom configuration shown in FIG. 26A.

FIG. 27 is a top plan view of the opened sleeve of FIG. 24 showing the inner bottom of the sleeve.

FIG. 28 is an elevational view of another embodiment of a sleeve constructed in accordance with the present invention wherein the perforations have a scalloped pattern.

FIG. 29 is an elevational view of another embodiment of a sleeve constructed in accordance with the present invention wherein the perforations have an inverted scalloped pattern.

FIG. 30 is an elevational view of another embodiment of a sleeve constructed in accordance with the present invention wherein the perforations have a wave pattern.

FIG. 31 is an elevational view of another embodiment of a sleeve constructed in accordance with the present invention wherein the perforations have a zig-zag pattern.

FIG. 32 is an elevational view of another embodiment of a sleeve constructed in accordance with the present invention wherein the perforations have a rectangular pattern.

FIG. 33 is an elevational view of another embodiment of a sleeve constructed in accordance with the present invention wherein the perforations are diagonally slanted.

FIG. 34 is a perspective view of a sleeve-forming apparatus showing a method of constructing a sleeve in accordance with the present invention.

FIG. 35 is an elevational view of a dual web roller feeding apparatus which can be used as an alternate method for feeding the webs shown in FIG. 34.

FIG. 36 is a plan view of an alternate sleeve-forming configuration.

FIG. 37 is a plan view of another sleeve-forming configuration.

FIG. 38 is a plan view of another sleeve-forming configuration.

FIG. 39 is a plan view of another sleeve-forming configuration.

FIG. 40 is a plan view of another sleeve-forming configuration.

FIG. 41 is an elevational view of another embodiment of a sleeve constructed in accordance with the present invention.

FIG. 42 is a cross-sectional view of the sleeve of FIG. 41 taken along line 42-42.

FIG. 43 is an elevational view of another embodiment of a sleeve constructed in accordance with the present invention.

FIG. 44 is a cross-sectional view of the sleeve of FIG. 43 taken along line 44-44.

### DESCRIPTION OF THE PREFERRED EMBODIMENTS

The present invention contemplates a plant packaging system comprising a sleeve having a decorative body comprising a base and a skirt for packaging a potted plant or floral grouping. The sleeve may have an upper portion which can be detached from the decorative body of the sleeve once the function of the upper portion has been completed. The decorative body and upper portion, when present, may comprise a unitary construction or may comprise separate components which are attached together by various bonding materials or attaching methods.

In general, the body is sized to substantially cover the outer peripheral surface of a pot. The upper portion, when present, may be detachable via a detaching element such as perforations, tear strips and zippers. In a preferred version of the invention the sleeve has a lower end having a half hexagonal (three-sided) configuration which enables the body, when opened, to form a pair of folded portions in the bottom which can be conveniently positioned underneath the pot when the pot is disposed within the body of the sleeve, thereby concealing the lower portions of the body of the sleeve within the folded portions.

The present invention in another version is a potted plant package, comprising a potted plant and a floral sleeve as described herein, and wherein the potted plant is disposed within an inner retaining space of the floral sleeve in an opened condition. The sleeves described herein may be used to hold floral groupings, i.e., as a vase. The sleeves described herein may also be used to decoratively contain non-botanical objects such as wine bottles or other gift items.

Further detail and explanation of the articles and methods of the present invention are forthcoming in the description provided below.

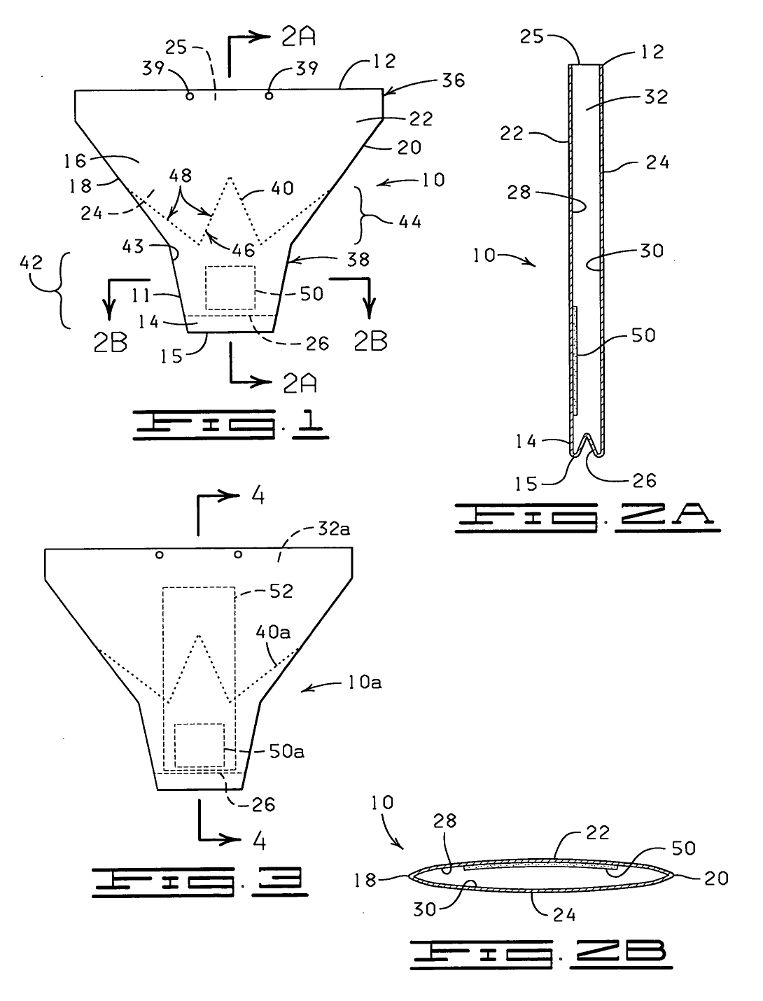

### The Embodiments and Methods of Use of FIGS. 1-15

Shown in FIGS. 1 and 2A-2B and designated therein by the general reference numeral 10 is a flexible sleeve (also referred to herein as a floral sleeve) of unitary construction. The sleeve 10 initially comprises a flexible flattened piece of material which is openable into the form of a tube. The sleeve 10 may be tapered outwardly from the lower end toward a larger diameter at its upper end. In its flattened state the sleeve 10 may have an overall trapezoidal, modified trapezoidal or contoured (non-linear) shape, and when opened is generally substantially frusto-conical. It will be appreciated, however, that the sleeve 10 may comprise variations on the aforementioned shapes or may comprise significantly altered shapes such as square or rectangular, wherein the sleeve 10 when opened has a cylindrical form, as long as the sleeve 10 functions in accordance with the present invention in the manner described herein.

The sleeve 10 comprises a body 11 which has an upper end 12, a lower end 14, an outer peripheral surface 16 and in its flattened state has a sealed first edge 18 and a sealed second edge 20 and a first side 22 (also referred to herein as a first panel) and a second side 24 (also referred to herein as a second panel). The sleeve 10 has an opening 25 at the upper end 12 and preferably has a closed bottom edge 15 at the lower end 14. Shown in FIG. 1, the lower end 14 is closed with a gusset 26, but it may be sealed along an edge without a gusset. The first side 22 has a first inner peripheral surface 28 and the second side 24 has a second inner peripheral surface 30 as shown in FIGS. 2A and 2B which together, when the sleeve 10 is opened, define and encompass an inner retaining space 32 as shown in FIG. 2A. When the lower end 14 of the sleeve 10 is closed, a portion of the lower end 14 may be inwardly folded to form one or more gussets 26, as noted above, for permitting a circular bottom of an object such as a potted plant to be disposed into the inner retaining space 32 of the lower end 14 of the sleeve 10.

The sleeve 10 preferably has a frusto-conically shaped portion, but the sleeve 10 may be, by way of example but not by way of limitation, cylindrical, frusto-conical, a combination of both frusto-conical and cylindrical, or any other shape, as long as the sleeve 10 functions as described herein as noted above. Further, the sleeve 10 may comprise any shape, whether geometric, non-geometric, asymmetrical and/or fanciful as long as it functions in accordance with the present invention. The sleeve 10 may also be equipped with drains in the lower end 14 or ventilation holes (not shown), or can be made from permeable or impermeable materials.

The material from which the sleeve 10 is constructed preferably has a thickness in a range from about 0.1 mil to about 30 mil, although in some cases the sleeve may be much thicker, especially when the sleeve is constructed from multiple layers. Often, the thickness of the sleeve 10 is in a range from about 0.5 mil to about 10 mil. Preferably, the sleeve 10 has a thickness in a range from about 1.0 mil to about 5 mil. More preferably, the sleeve 10 is constructed from material which is flexible, semi-rigid, rigid, or any combination thereof. The sleeve 10 may be constructed of a single layer of material or a plurality of layers of the same or different types of materials. Any thickness of the material may be utilized as long as the material functions in accordance with the present invention as described herein. The layers of material comprising the sleeve 10 may be connected together or laminated or may be separate layers. Such materials used to construct the sleeve 10 are described in U.S. Pat. No. 5,111,637, which is hereby expressly incorporated herein by reference. Any thickness of material may be utilized in accordance with the present invention as long as the sleeve 10 may be formed as described herein, and as long as the formed sleeve 10 may contain at least a portion of a pot or potted plant or a floral grouping, as described herein. Additionally, an insulating material such as bubble film, preferable as one of two or more layers, can be utilized in order to provide additional protection for the item, such as the floral grouping, contained therein.

In one embodiment, the sleeve 10 may be constructed from two polypropylene films. The material comprising the sleeve 10 may be connected together or laminated or may be separate layers. In an alternative embodiment, the sleeve 10 may be constructed from only one of the polypropylene films.

The sleeve 10 is constructed from any suitable material that is capable of being formed into a sleeve and wrapped about a pot and a floral grouping disposed therein. Preferably, the material comprises untreated or treated paper, metal foil, polymeric film, non-polymeric film, woven or nonwoven fabric, synthetic or natural fabric, cardboard, fiber, cloth, burlap, or laminations or combinations thereof.

The term “polymeric film” means a man-made polymer such as a polypropylene or a naturally occurring polymer such as cellophane. A polymeric film is relatively strong and not as subject to tearing (substantially non-tearable), as might be the case with paper or foil.

The material comprising the sleeve 10 or the sleeve 10 itself (or any other sleeve described herein) may vary in color and may consist of designs or decorative patterns which are printed, etched, and/or embossed thereon using inks or other printing materials. An example of an ink which may be applied to the surface of the material is described in U.S. Pat. No. 5,147,706 entitled “Water Based Ink On Foil And/Or Synthetic Organic Polymer” issued to Kingman on Sep. 15, 1992 and which is hereby incorporated herein by reference.

In addition, the material used to make the sleeves may have various colorings, coatings, flocking and/or metallic finishes, or other decorative surface ornamentation which are applied separately or simultaneously or may be characterized totally or partially by pearlescent, fluorescent, translucent, transparent, iridescent, neon, or the like, qualities. Each of the above-named characteristics may occur alone or in combination and may be applied to the upper and/or lower surface of the material comprising the sleeve 10. Moreover, portions of the material used in constructing the sleeve 10 may vary in the combination of such characteristics. The material utilized for the sleeve 10 itself may be opaque, translucent, transparent, or partially clear or tinted transparent.

Any of the sleeves described herein may be decorated with printed patterns or designs, or may simply be pigmented with one or more colors (for example, the pigment, die, or other colorant, can be introduced into the resin when a polymeric film (used to construct the sleeve) is produced, forming a homogeneous coloring in the sleeve, or forming for example, swirls or bands of color. This technique could be used in conjunction with designs or decorations printed thereon, for example, to produce a sleeve having one side with a colored background and one side with a printed background.

It will generally be desired to use the sleeve 10 as a covering for a potted plant such as is well known in the art. The term “pot” as used herein refers to any type of container used for holding a floral grouping or plant. Examples of pots, used in accordance with the present invention include, but not by way of limitation, clay pots, foam pots, wooden pots, plastic pots, pots made from natural mud/or synthetic fibers, or any combination thereof. The pot is adapted to receive a floral grouping in the retaining space. The floral grouping may be disposed within the pot along with a suitable growing medium described in further detail below, or other retaining medium, such as a floral foam. It will also be understood that the floral grouping, and any appropriate growing medium or other retaining medium, may be disposed in the sleeve 10 (or any sleeve described herein) without a pot for cultivation or display of the floral grouping.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping comprises a bloom or foliage portion and a stem portion. Further, the floral grouping may comprise a growing potted plant having a root portion (not shown) as well. However, it will be appreciated that the floral grouping may consist of only a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule.”

The term “growing medium” when used herein means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet or floral grouping.

The term “propagule” when used herein means any structure capable of being propagated or acting as an agent of reproduction including seeds, shoots, stems, runners, tubers, plants, leaves, roots or spores.

In accordance with the present invention, a bonding material designated by the general reference numeral 50 is preferably disposed on a portion of the sleeve 10 to assist in holding the sleeve 10 to the pot (not shown) having the floral grouping (not shown) therein when such a pot is disposed within the sleeve 10 or to assist in closing the upper end of the sleeve 10 or adhering the sleeve 10 to the pot after the pot has been disposed therein, as will be discussed in further detail below.

It will be understood that the bonding material 50 may be disposed as a strip or block on a surface of the sleeve 10 as is described in more detail herein. The bonding material 50 may also be disposed upon either the first side 22, the second side 24, the first inner peripheral surface 28, or the second inner peripheral surface 30, of the sleeve 10, as well as upon the pot. Further, the bonding material 50 may be disposed as spots of bonding material, or in any other geometric, non-geometric, asymmetric, or fanciful form and in any pattern including covering either both inner peripheral surfaces 28 and 30 and/or outer peripheral surface 16 of the sleeve 10 and/or the pot or pot cover (not shown).

The bonding material 50 may be covered by a cover material or release material 52 which can be removed prior to the use of the sleeve 10, pot or pot cover. The bonding material 50 can be applied by means known to those of ordinary skill in their art. One method for disposing a bonding material, in this case an adhesive, is described in U.S. Pat. No. 5,111,637 which has been incorporated by reference above.

The term “bonding material” when used herein means an adhesive, frequently a pressure sensitive adhesive, or a cohesive. When the bonding material 50 is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonic sealable and vibratory sealable. The term “bonding material” when used herein also means a heat sealing lacquer or hot melt material which may be applied to the material and, in this instance, heat, sound waves, or vibrations, also must be applied to effect the sealing.

The term “bonding material” when used herein also means any type of material or thing which can be used to effect the bonding or connecting of the two adjacent portions of the material or sheet of material to effect the connection or bonding described herein. The term “bonding material” may also include ties, labels, rubber or elastic bands, ribbons, strings, tapes (including single or double-sided adhesive tapes), staples, wires or combinations thereof which may be used in accordance with the present invention. Some of the bonding materials would secure the ends of the material while other bonding material may bind the circumference of a wrapper, or a sleeve, or, alternatively and/or in addition, the bonding materials would secure overlapping folds in the material and/or sleeve. Another way to secure the wrapping and/or sleeve is to heat seal the ends of the material to another portion of the material. One way to do this is to contact the ends with an iron of sufficient heat to heat seal the material.

Alternatively, a cold seal adhesive may be utilized as the bonding material. The cold seal adheres only to a similar substrate, acting similarly as a cohesive, and binds only to itself. The cold seal adhesive, since it bonds only to a similar substrate, does not cause a residue to build up on equipment, thereby both permitting much more rapid disposition and use of such equipment to form articles and reducing labor costs. Further, since no heat is required to effect the seal, the dwell time, that is, the time for the sheet of material to form and retain the desired shape is reduced. A cold seal adhesive binds quickly and easily with minimal pressure, and such a seal is not readily releasable. This characteristic is different from, for example, a pressure sensitive adhesive.

The term “bonding material” when used herein also means any heat or chemically shrinkable material, and static electrical or other electrical elements, chemical welding elements, magnetic elements, mechanical or barb-type fastening elements or clamps, curl-type characteristics of the film or materials incorporated in material which can cause the material to take on certain shapes, cling films, slots, grooves, shrinkable materials such as heat shrinkable materials, and bands, curl materials, springs and any type of welding method which may weld portions of the material to itself or to the pot, or to both the material itself and the pot and which functions in accordance with the present invention.

Any of the bonding materials described herein may be used as a securing element to secure any of the floral sleeves described herein in position about a pot and/or floral grouping. The securing element when placed about the floral sleeve disposed about a pot, may be positioned below or above an upper rim of the pot.

Certain versions of the sleeve 10 described herein may be used in conjunction with a preformed plant cover as explained in greater detail below.

As shown in FIG. 1, the sleeve 10 is demarcated into an upper portion 36 and a lower portion 38. The lower portion 38 of the sleeve 10 is generally sized to contain a potted plant when opened (not shown). The upper portion 36 may optionally have apertures 39 (shown in FIG. 1) near the upper end 12 thereof for allowing the sleeve 10 to be supported by a support mechanism such as a pair of wickets (not shown) such as is known in the art. The upper portion 36 of the sleeve 10 is generally sized to substantially surround and encompass the floral grouping of the potted plant disposed within the lower portion 38 of the sleeve 10. The sleeve 10 is demarcated into the upper portion 36 and the lower portion 38 by a detaching element 40 (shown in FIG. 1) for enabling the detachment of the upper portion 36 of the sleeve 10 from the lower portion 38 of the sleeve 10. In the version shown in FIG. 1, the detaching element 40 is a plurality of perforations which extends across the outer peripheral surface 16 of the sleeve 10 from the first edge 18 to the second edge 20.

The term “detaching element,” as used generally herein, means any element, or combination of elements, or features, such as, but not limited to, perforations, tear strips, tear starts, zippers, and any other devices or elements of this nature known in the art, or any combination thereof, which enable or facilitate the tearing away or detachment of one object from another. Therefore, while perforations are shown and described in detail herein, it will be understood that tear strips, zippers, or any other “detaching elements” known in the art, or any combinations thereof, could be substituted therefor and/or used therewith. The sleeve 10 may comprise drainage or ventilation holes in the upper or lower portions for allowing movement of gases or moisture to and away from the inner space of the sleeve (not shown).

In a preferred embodiment, as shown in FIG. 1, the lower portion 38 of the sleeve 10 further comprises a base portion 42, and a skirt portion 44. The base portion 42 comprises that part of the lower portion 38 which, when the pot is placed into the lower portion 38, has an inner peripheral surface 43 which is substantially adjacent to and surrounds the outer peripheral surface of the pot (not shown). The skirt portion 44 comprises that part of the upper portion 36 which extends beyond the upper rim of the pot (not shown) and adjacent at least a portion of the floral grouping contained within the pot and which is left to freely extend straight from or at angle, inwardly or outwardly, from the base portion 42 when the upper portion 36 of the sleeve 10 is detached from the lower portion 38 of the sleeve 10 by actuation of the detaching element 40. In the intact sleeve 10, the skirt portion 44 comprises an upper peripheral edge 46 generally congruent with the detaching element 40 which is connected to a lower peripheral edge 48 of the upper portion 36 of the sleeve 10 also congruent with the detaching element 40. In FIG. 1, the upper peripheral edge 46 of the skirt portion 44 is congruent with a series of perforations which together comprise the detaching element 40.

The upper portion 36 of the sleeve 10 may also have an additional detaching element (not shown) such as a plurality of vertical perforations for facilitating removal of the upper portion 36 and which are disposed more or less vertically therein extending from the detaching element 40 to the upper end 12 of the sleeve 10. When the vertical detaching element is present the upper portion 36 of the sleeve 10 is separable from the lower portion 38 of the sleeve 10 by tearing the upper portion 36 along both the vertical perforations and along the detaching element 40, thereby separating the upper portion 36 from the lower portion 38 of the sleeve 10. The lower portion 38 of the sleeve 10 remains disposed as the base portion 42 about the pot (not shown) and as the skirt portion 44 about the floral grouping (not shown) which extends from the pot forming a decorative cover which substantially surrounds and encompasses the potted plant.

It will be understood that equipment and devices for forming standard floral sleeves are commercially available, and are well known to a person of ordinary skill in the art. A preferred method is discussed below.

As noted above, the sleeve 10 preferably has a closed lower end 14. When the lower end 14 is closed the lower end 14 may have one or more gussets 26 formed therein for allowing expansion of the lower end 14 when an object with a broad lower end such as a pot is disposed therein. In another version of the present invention the lower end 14 may be completely or partially open.

In the preferred version of the present invention, the sleeve 10 further includes an area of bonding material 50 disposed upon a portion of the first inner peripheral surface 28 of the base portion 42 of the sleeve 10. In another version of the present invention, the sleeve 10 may be constructed without a bonding material thereon (not shown). In this case, the sleeve 10 may be attached to the outer surface of the pot disposed therein by a bonding material 50 applied to the outer surface of the pot. The area of bonding material 50, when present, functions to enable the first inner peripheral surface 28, or a portion thereof, to be bondingly connected to the outer peripheral surface of the pot (not shown) disposed therein causing the sleeve 10 to be bondingly connected to the pot.

The sleeve 10 in FIG. 2A is shown as partially opened, however, the sleeve 10 is generally provided to the operator in a substantially flattened condition and usually as one of a stack of sleeves. During the process of covering the pot, the sleeve 10 is opened, manually or automatically. In the flattened condition of the sleeve 10, the bonding material 50 on the first inner peripheral surface 28 may partially adhere to the second inner peripheral surface 30 of the sleeve 10. Obviously, it is desirable to avoid a situation in which the bonding material 50 is permanently or strongly bonded to the second inner peripheral surface 30 of the sleeve 10 because this would make it difficult for the sleeve 10 to be manually or automatically opened for insertion of the pot. As a result, the bonding material 50 may be made of an adhesive composition which has a low degree of tackiness such that if the bonding material 50 does adhere to the second inner peripheral surface 30 it can be easily separated from the second inner peripheral surface 30 when the sleeve 10 is opened up. Such adhesives with low tackiness are well known to those of ordinary skill in the art and are commercially available.

Alternatively, the bonding material 50 can be composed of a cohesive material. Since the cohesive is applied to only one of the inner peripheral surfaces 28 or 30 (surface 28 as shown in FIG. 2A or 2B), the cohesive will not bond to the opposite surface (second inner peripheral surface 30 in FIG. 2A or 2B) as long as there is no opposing cohesive material to which it can bond. In this version of the invention, in order for the first inner peripheral surface 28 of the sleeve 10 to be bonded to a pot disposed therein, an area of cohesive material to which the bonding material 50 can cohere must be present on at least a portion of the outer surface of the pot (not shown). Once the pot is inserted into the sleeve 10, the areas of bonding material 50 can be pressed together to bondingly connect the sleeve 10 to the pot.

In yet another version of the present invention, shown in FIGS. 12-15 of U.S. Pat. No. 5,625,979 which is expressly incorporated by reference herein in its entirety, a bonding material is disposed on a portion of the outer peripheral surface of the base portion of the sleeve 10. After the pot is disposed in the retaining space of the base portion, the sleeve 10 is manually or automatically crimped about the outer peripheral surface of the pot in the vicinity of the bonding material thereby forming overlapping folds in the base portion which are bondingly connected together by the bonding material to add structural integrity to the base portion of the sleeve and to cooperate to hold the base portion in the shape of a pot cover or for causing the base portion of the sleeve 10 to engage the outer peripheral surface of the pot and be held firmly thereabout. The bonding material may be disposed on the sleeve 10 at a position below the upper rim of the pot or may be disposed at a position on the base portion of the sleeve 10 above the upper rim of the pot such that the overlapping folds crimpingly formed are located in a position generally above the upper rim of the pot.

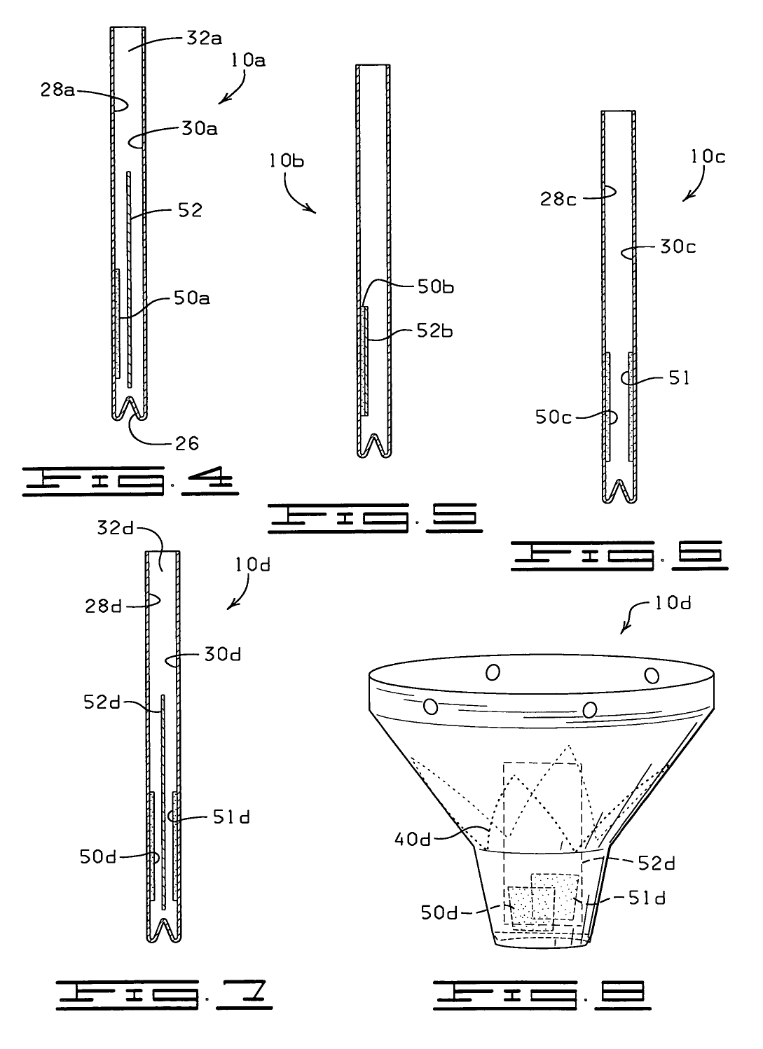

A material can be disposed between the bonding material 50 and the second inner peripheral surface 30 for preventing the adherence of the bonding material 50 to the second inner peripheral surface 30. Shown in FIGS. 3 and 4 is a sleeve 10a similar to sleeve 10 except that a piece of release material 52 is disposed within the inner retaining space 32a of the sleeve 10a wherein the release material 52 serves as a barrier between the bonding material 50a which is disposed on the first inner peripheral surface 28a (shown in FIG. 4) and the second inner peripheral surface 30a (shown in FIG. 4) thereby preventing the bonding material 50a from bonding to the second inner peripheral surface 30a. The release material 52 is constructed of a material which will not adhere to the bonding material 50a. Such release materials are well known to those of ordinary skill in the art and are available commercially.

During operation, when the sleeve 10a is opened in anticipation of disposing a pot therein, after opening, the release material 52 can be removed from the inner retaining space 32a of the sleeve 10a prior to insertion of the pot therein. In yet another version of the invention, FIG. 5 shows a sleeve 10b having a bonding material 50b having a piece of release material 52b disposed directly thereon in a manner well known in the art. The release material 52b can be removed from the opened sleeve 10b immediately before insertion of the pot.

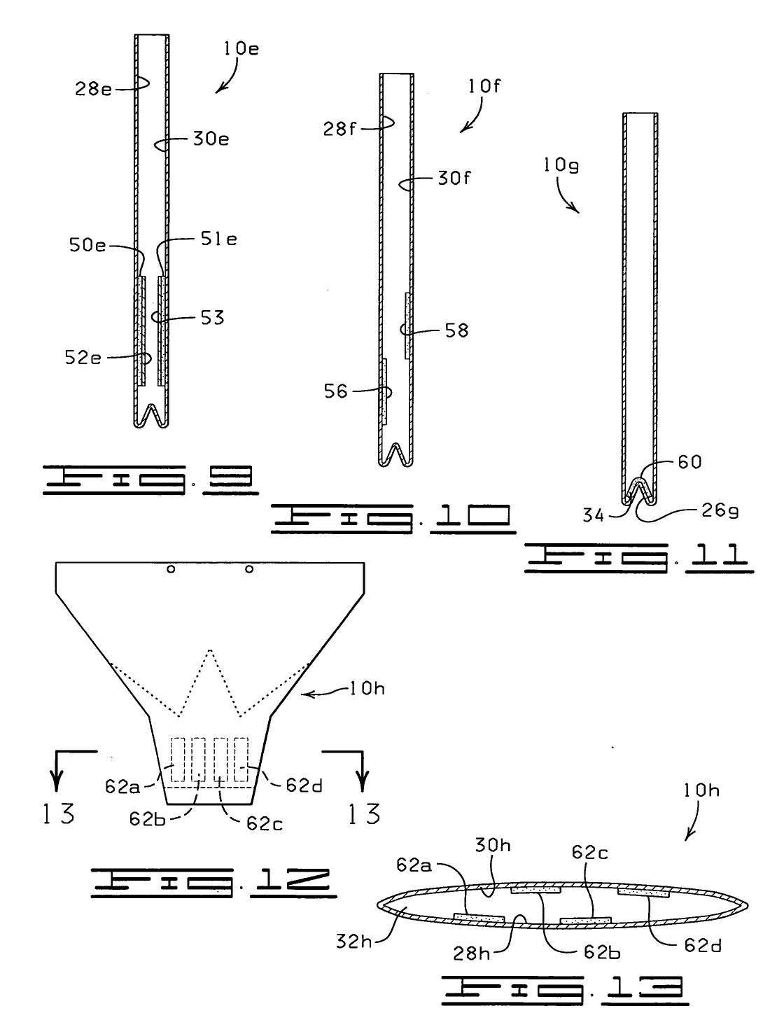

Shown in FIG. 6 is a sleeve 10c similar to sleeve 10 except that in addition to having a bonding material 50c disposed on the first inner peripheral surface 28c, the sleeve 10c also has an opposing bonding material 50c disposed on the second inner peripheral surface 30c. The bonding materials 50c and 51 are constructed of a material having low tackiness so that in the event the bonding material 50c adheres to the opposing bonding material 51, the sleeve 10c can still be easily opened for insertion of a pot. FIG. 7 shows a sleeve 10d which is similar to sleeve 10c except that a piece of release material 52d is inserted into the inner retaining space 32d of the sleeve 10d in the same manner as that shown in FIG. 4 wherein the release material 52d is disposed between the areas of bonding materials 50d and 51d. FIG. 8 shows a perspective view of an opened sleeve 10d with the release material 52d still disposed therein.

FIG. 9 shows a sleeve 10e which is similar to sleeve 10c in FIG. 6 except that each area of bonding materials 50e and 51e has a release material 52e and second release material 53 disposed directly thereon, respectively, in a manner as discussed above for sleeve 10b.

FIG. 10 shows a sleeve 10f which is similar to sleeve 10 except the sleeve 10f has a first area of bonding material 56 and a second area of bonding material 58 which are disposed on first and second inner peripheral surfaces 28f and 30f, respectively, and which are disposed at staggered positions such that bonding material 56 is positioned lower than the bonding material 58.

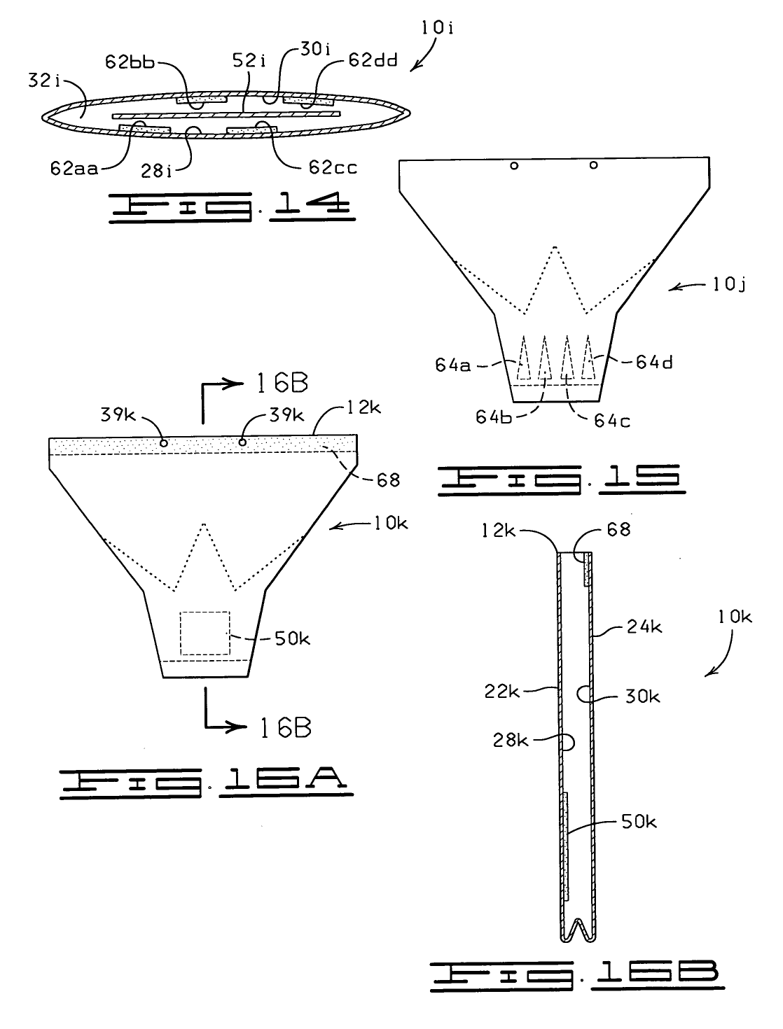

FIG. 11 shows a sleeve 10g which is similar to sleeve 10 except that the sleeve 10g has a bonding material 60 which is disposed on the inner bottom surface 34 of the sleeve 10g, for example, upon the portion of the sleeve 10g which forms the gusset 26g of the sleeve 10g. When the sleeve 10g is opened for insertion of a pot, the outer bottom surface of the pot (not shown) is bondingly connected to the inner bottom 34 of the sleeve 10g by the bonding material 60.

FIGS. 12 and 13 show a sleeve 10h constructed in accordance with the present invention which is similar to sleeve 10 except for differences in the positioning of the bonding materials 62a-62d disposed upon the first and second inner peripheral surfaces 28h and 30h, respectively, of the sleeve 10h. Sleeve 10h is shown as having four areas of bonding material 62a, 62b, 62c and 62d. The areas of bonding material 62a-62d are alternately positioned upon the first and second inner peripheral surfaces 28h and 30h, respectively, of the sleeve 10h as shown in FIG. 13 so that the areas of bonding material 62a-62d are staggered and so that if the sleeve 10h is flattened no area of bonding material will be pressed against another area of bonding material. The sleeve 10h can thus be more easily opened.

FIG. 14 shows a sleeve 10i which is similar to sleeve 10h except that sleeve 10i has a piece of release material 52i inserted into the inner retaining space 32i so that areas of bonding material 62aa and 62cc are separated from areas of bonding material 62bb and 62dd whereby the areas of bonding material 62aa-62dd do not adhere to opposite first and second inner peripheral surfaces of the sleeve 10i.

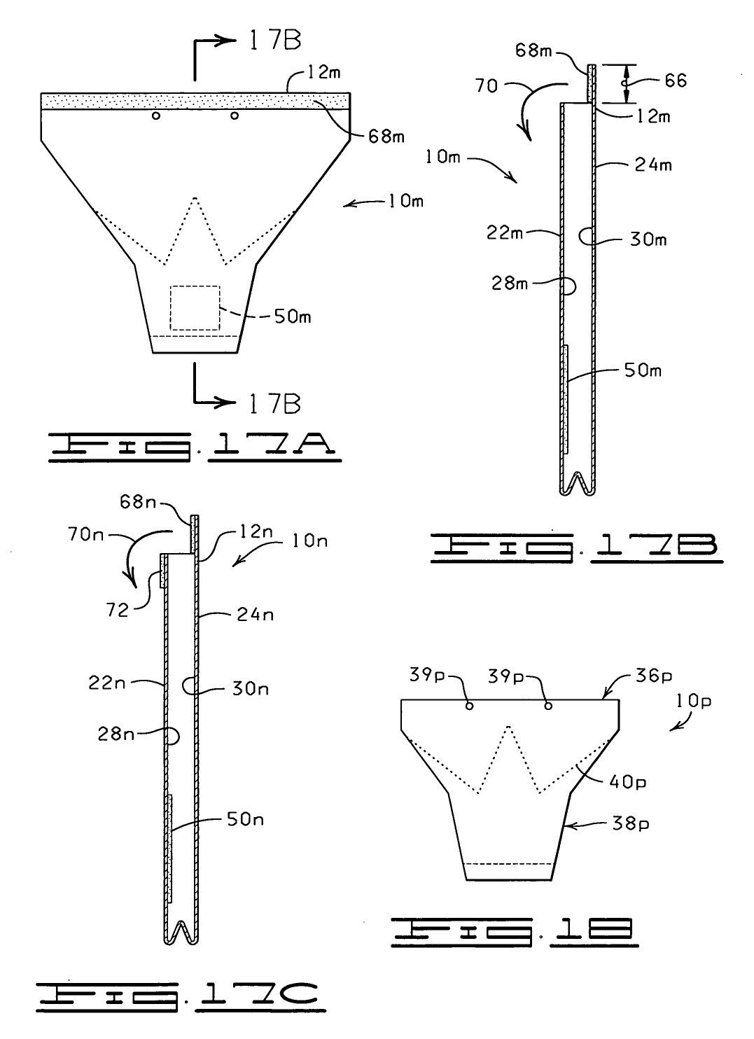

Shown in FIG. 15 is a sleeve 10j which is similar to sleeve 10h except that sleeve 10j has areas of bonding material 64a-d which substantially correspond to areas of bonding material 62a-d in sleeve 10h except that the areas of bonding material 64a-d have triangular instead of rectangular shapes. In fact, it will be apparent to one of ordinary skill in the art that the number of areas of bonding material of the inner peripheral surface and their shapes and arrangements on the sleeve can be varied. In another version of the invention, not shown, the bonding material may be positioned in a spiral pattern on the inner surface of the lower portion of the sleeve.

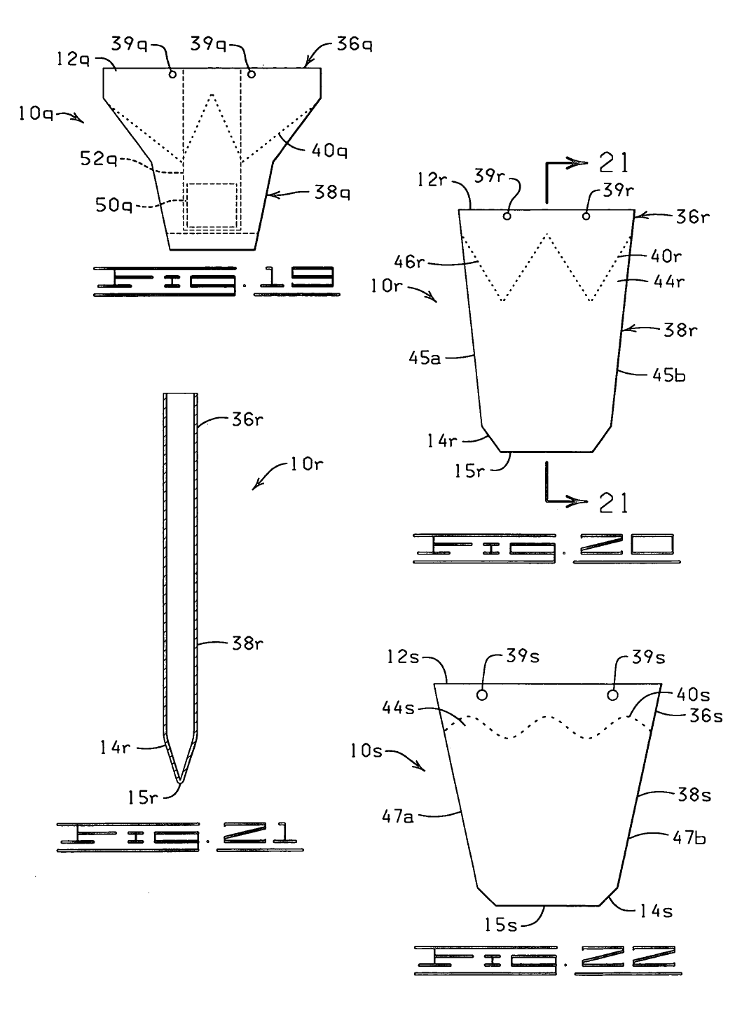

### Embodiments of FIGS. 16A-17C

Shown in FIGS. 16A and 16B is a sleeve 10k similar to sleeve 10 except that a closure bonding material 68 is disposed upon a portion of the second inner peripheral surface 30k as shown in FIG. 16A (or alternatively, the first inner peripheral surface 28k). After a pot (not shown) has been disposed within the sleeve 10k, the upper end 12k of the sleeve 10k can be pressed together, causing the closure bonding material 68 to adhere to a portion of the first inner peripheral surface 28k to effect closure of the upper end 12k of the sleeve 10k.

Shown in FIGS. 17A and 17B is a sleeve 10m which is an alternate version of the sleeve 10 in which the upper end 12m of the second side 24m extends a distance 66 beyond the upper end 22m of the first side 22m. Disposed upon the upper end 12m of the second inner peripheral surface 30m of the second side 24m is a closure bonding material 68m. After a pot (not shown) is disposed within the sleeve 10m, the upper end portion of the second side 24m with closure bonding material 68 disposed thereon can be folded in a direction 70 onto an upper end portion of first side 22m thereby sealing the upper end 12m of the sleeve 10m.

Shown in FIG. 17C is a sleeve 10n which is similar to sleeve 10m except there is a second closure bonding material 72 which is disposed upon an upper end portion of side 22n. When the upper end portion of second side 24n having the closure bonding material 68n is folded over onto first side 22n, the closure bonding material 68n bondingly engages closure bonding material 72 thereby effecting a seal in the upper end 12n of sleeve 10n. Preferably, in this version, the closure bonding materials 68n and 72 are both cohesive materials so that when another sleeve 10n is pressed against the sleeve, neither bonding material 68n nor 72 will cause the adjacent sleeves 10n to be connected to each other thereby facilitating the separation of sleeves 10n from the batch. It will be understood by one of ordinary skill in the art that the arrangements and types of closure bonding materials described in FIGS. 16A-17C are applicable to all other embodiments of sleeves described herein including sleeves with and without bonding material.

### Embodiments of FIGS. 18-25

Shown in FIG. 18 is a sleeve 10p which is similar to sleeve 10 except that (1) it does not have a bonding material 50 disposed upon a portion of the inner surface thereof and (2) the upper portion 36p is not sized so as to substantially encompass the floral grouping portion of a potted plant disposed therein. Rather, the upper portion 36p in this case performs the primary function of holding the lower portion 38p upon a support assembly (not shown) via apertures 39, such as a wicket as described above. The upper portion 36p in this case is then intended to be removed via detaching element 40p before a potted plant is placed in the sleeve 10p.

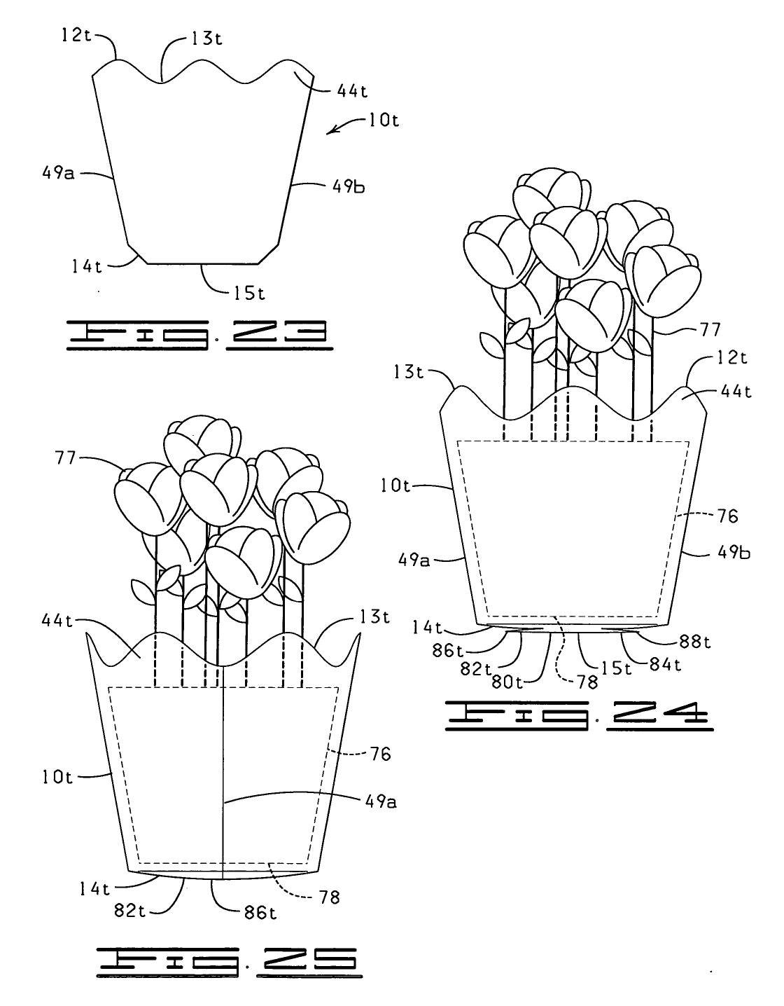

FIG. 19 shows a sleeve 10q which is similar to sleeve 10p except that it has a bonding material 50q disposed therein for connecting to a pot (not shown) disposed therein. Further, optionally, sleeve 10q may be equipped with a release material 52q which is attached to the upper portion 36q of the sleeve 10q, or which extends to near the upper end of the upper portion 36q so that when the upper portion 36q is detached from the sleeve 10q during use of this version of the invention, the release material 52q is removed along with the upper portion 36q thereby eliminating the separate step of removing the release material 52q separately.

FIG. 20 shows a sleeve 10r having a flattened condition. Sleeve 10r has an upper end 12r, a lower end 14r having a bottom edge 15r, an upper portion 36r which is detachable from a lower portion 38r via a detaching element 40r. Sleeve 10r may be constructed to have the features of any other sleeve described herein except as noted below. The lower end 14r may be completely or partially closed. The upper portion preferably has apertures 39r for enabling the sleeve 10r to be supported from a support device such as a wicket. The upper portion 36r may be sized sufficiently large to surround and encompass a floral grouping disposed within the pot or may be sized so that it is only sufficient to be used to support the sleeve 10r from a support device or enable it to be connected to other sleeves 10r in a pad. Sleeve 10r is shown in cross-section in FIG. 21. The lower portion 38r further comprises a skirt portion 44r which has an upper edge 46r when the upper portion 36 is detached from the lower portion 38r. The lower portion 38r has a left side edge 45a and a right side edge 45b which angle inwardly near the lower end 14r to form a shape of a half hexagon (a three sided shape) with bottom edge 15r. The bottom edge 15r is constructed with a straight seal (or optionally with a curved seal, not shown) between left side edge 45a and right side edge 45b. Sleeve 10r is formed with no gusset in the lower end 14r although in an alternative embodiment the lower end 14r may have a gusset. It will be appreciated that sleeve 10r may also have a bonding material disposed upon a portion of the inner peripheral surface (not shown) thereof as described elsewhere herein.

Any of the sleeves shown herein may be formed from a tube of material (not shown) which has been flattened and in which a lower portion has been removed to form a tapered lower portion such as shown in FIGS. 18 and 20, for example. A gusset may be formed in the lower end of the sleeve (FIG. 18) or the sleeve may be left without a gusset in the lower end (FIG. 20). The sleeves may be formed from one or two or more webs of material, as discussed in more detail below.

FIG. 22 shows a sleeve 10s having a flattened condition. Sleeve 10s is similar to sleeve 10r, and sleeve 10s has an upper end 12s, a lower end 14s (partially or completely closed) having a bottom edge 15s, an upper portion 36s which is detachable from a lower portion 38s via a detaching element 40s. The upper portion 36s preferably has apertures 39s for enabling the sleeve 10s to be supported from a support device such as a wicket or other support device or padding device known in the art. The lower portion 38s further comprises a skirt portion 44s which has a free upper edge 46s when the upper portion 36s is detached from the lower portion 38s. The detaching element 40s, in the embodiment of FIG. 22, has a curved pattern such that when the upper portion 36s is detached, the upper edge 46s which is formed has a curved (non-linear) shape. In one embodiment, the upper portion 36s is sized sufficiently large to surround and enclose a plant or floral grouping disposed within the pot which the lower portion 38s is sized to contain. For example, the distance between the upper end 12s and bottom edge 15s in the flattened condition may be 293 mm while the distance between the lowest portion of the detaching element 40s and the bottom edge 15s in the flattened condition may be 148 mm. The lower portion 38s has a left side edge 47a and a right side edge 47b which angle inwardly near the lower end 14s between bottom edge 15s to form a shape of a half hexagon. The bottom edge 15s is constructed with a straight seal (or curved seal, not shown) between left side edge 47a and right side edge 47b. Sleeve 10s is formed with no gusset in the lower end 14s although in an alternative embodiment the lower end 14s may have a gusset. It will be appreciated that sleeve 10s may also have a bonding material disposed upon a portion of the inner peripheral surface (not shown) thereof as described elsewhere herein. The detaching element 40s may have other patterns such as those shown elsewhere herein.

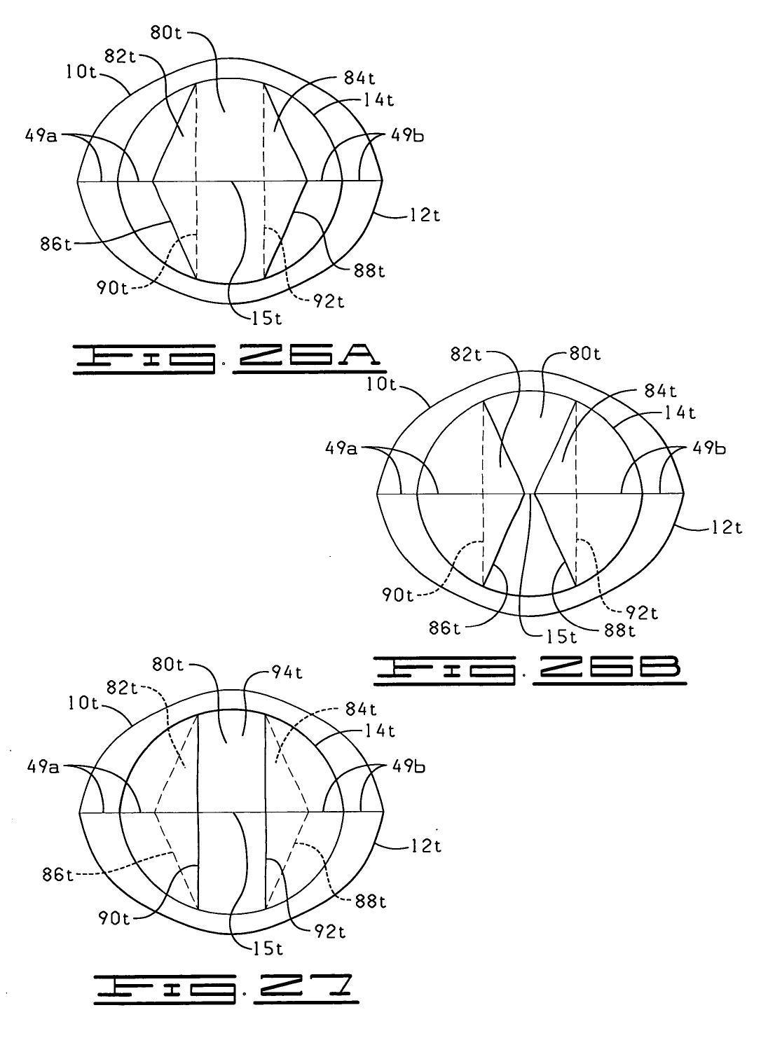

FIG. 23 shows a sleeve 10t having a flattened condition. Sleeve 10t is similar to sleeve 10s and has an upper end 12t having an upper edge 13t, and a lower end 14t (partially or completely closed) having a bottom edge 15t. The sleeve 10t comprises a skirt portion 44t which has the upper edge 13t. The upper edge 13t has a curved (non-linear) shape. The sleeve 10t may be produced to have the upper edge 13t free when constructed, or may be produced from a sleeve such as sleeve 13s when the upper portion 36s is detached therefrom during manufacturing or during use by a user of the sleeve 10s. The sleeve 10t has a left side edge 49a and a right side edge 49b which angle inwardly toward bottom edge 15s near the lower end 14t to form a shape of a half hexagon. The bottom edge 15t is constructed with a straight seal (or curved seal, not shown) between left side edge 49a and right side edge 49b. Sleeve 10t is formed with no gusset in the lower end 14t although in an alternative embodiment the lower end 14t may have a gusset. It will be appreciated that sleeve 10t may also have a bonding material disposed upon a portion of the inner peripheral surface (not shown) thereof as described elsewhere herein.

Shown in FIG. 24 is a pot 76, having a floral grouping 77 disposed therein, which is positioned within the sleeve 10t which is in an opened condition. When the pot 76 is placed within the sleeve 10t, a bottom 78 of the pot 76 pushes against the lower end 14t of the sleeve 10t from the inside to form a folded bottom 80t having at least a first folded portion 82t and a corresponding second folded portion 84t. The first folded portion 82t and the second folded portion 84t (and similar elements described elsewhere herein) may also be each referred to herein as an “external gusset”. The first folded portion 82t has a fold edge 86t and the second folded portion has a fold edge 88t. The first folded portion 82t and the second folded portion 84t are substantially concealed underneath the pot 76 when the pot 76 is disposed in the sleeve 10t. Shown in FIG. 25 is the same opened sleeve 10t and pot 76 of FIG. 24, except the opened sleeve 10t and pot 76 have been rotated 90° in a counter-clockwise direction.

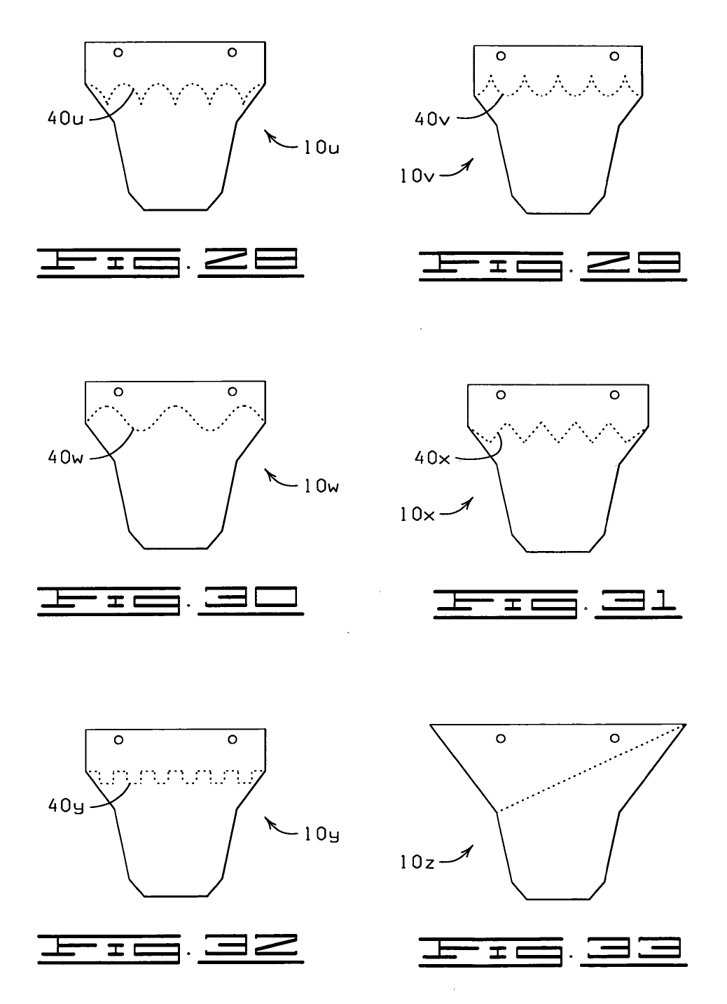

Shown in FIG. 26A is the sleeve 10t in the opened condition as shown in FIGS. 24-25 except the sleeve 10t in FIG. 26A does not have the pot 76 disposed therein. FIG. 26A shows a bottom plan view of the opened sleeve 10t. Visible in the bottom plan view are the bottom 80t, the first folded portion 82t and the second folded portion 84t, the fold edge 86t of the first folded portion 82t, and the fold edge 88t of the second folded portion 84t. Also visible are the left side edge 49a, the right side edge 49b, and the bottom edge 15t. The upper end 12t appears as an outer edge of the sleeve 10t. A first inner fold 90t, which corresponds to the first folded portion 82t, and a second inner fold 92t which corresponds to the second folded portion 84t, are shown in phantom and are described further below. Shown in FIG. 26B is the same opened sleeve 10t except the first and second folded portions 82t and 84t have been folded and oriented in an alternate direction. Other orientations of the first and second folded portions 82t and 84t can be contemplated by a person of ordinary skill in the art.

Shown in FIG. 27 is the sleeve 10t of FIGS. 24-25 without pot 76, except the sleeve 10t is viewed from above toward the inner bottom, i.e., toward the inside of the opened sleeve 10t. FIG. 27 shows bottom edge 15t, left side edge 49a, right side edge 49b, bottom 80t, first folded portion 82t, second folded portion 84t, fold edge 86t, and fold edge 88t in phantom. The first inner fold 90t of first folded portion 82t and the second inner fold 92t of second folded portion 84t are visible as portions of an inner bottom surface 94t of sleeve 10t. The configurations of sleeve 10t in the opened condition, shown in FIGS. 24-27 are the preferred configuration formed when a person of ordinary skill in the art disposed a pot 76 within the sleeve 10t. Other configurations comprising different fold patterns are not excluded from the invention as contemplated herein and will be apparent to persons of ordinary skill in the art who employ any of the sleeves 10r-10t, or other sleeves described herein, as flower pot coverings, or as containers of floral groupings with or without pots and/or growing or retaining media. The first folded portion 82t and second folded portion 84t can be formed either when the pot 76 is disposed in the sleeve 10t, by the pressure of the sleeve 10t against the pot 76, or manually, by insertion of the hand of the user into the sleeve 10t.

### Embodiments of FIGS. 28-33

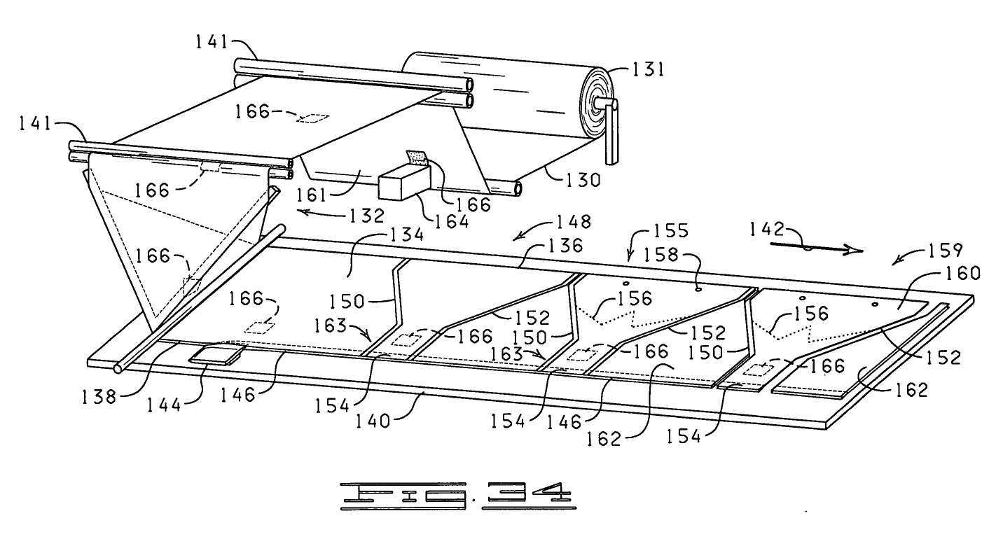

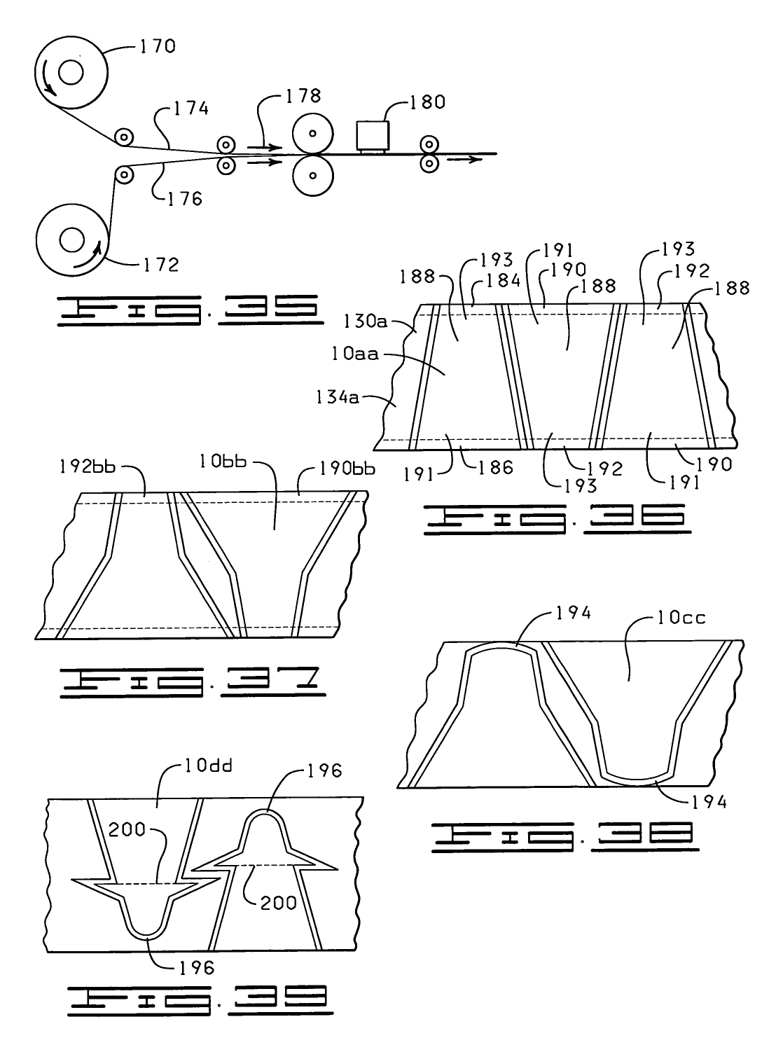

Shown in FIGS. 28-33 are sleeves which are similar to sleeves 10r-10s except each has an alternative arrangement of perforations for enabling separation of the upper portion of a sleeve from the lower portion. Sleeve 10u in FIG. 28 has a detaching element 40u comprising perforations having a scalloped pattern. FIG. 29 shows a sleeve 10v which has a detaching element 40v comprising perforations having an upside-down, or inverted, scalloped pattern. FIG. 30 shows a sleeve 10w which has a detaching element 40w comprising perforations having a wavy or sine-wave type pattern. FIG. 31 shows a sleeve 10x which as a detaching element 40x having a toothed or zig-zag perforation pattern. FIG. 32 shows a sleeve 10y which has a detaching element 40y comprising perforations having a rectangular pattern. Shown in FIG. 33 is a sleeve 10z having a detaching element 40z which comprises perforations having a diagonally-oriented pattern.

Each of these sleeves, as for the other sleeves described herein, may have a vertically-oriented line of perforations or other detaching element extending from the upper end of the sleeve to the other line of perforations for facilitating removal of the upper portion. Any of the sleeves described herein may have detaching elements having similar patterns, or may have free upper edges which have shapes or patterns like the detaching element patterns described herein.

Preferably, the sleeves described herein are characterized in that they are constructed substantially without preformed creases, folds, or score lines in the outer peripheral surfaces thereof, except along the right and left sides of the sleeve, or in the lower end of the sleeve in those versions where the lower end is sealed or closed or constructed with gussets.

The absence of preformed score lines, creases or folds benefits application of the sleeve about the pot in that it allows folds to be formed in positions in the sleeve other than those predetermined by the preformed lines or creases and does not necessarily cause folds to be formed in non-preferred positions in the sleeve.

### Construction of the Sleeves—FIGS. 34-40

It will be readily appreciated by those of ordinary skill in the art that processes for making standard floral sleeves which have open upper and lower ends are well known. In the preferred embodiment of the present invention, the sleeve is constructed with a closed bottom which may simply comprise a seal along the lower end of the sleeve or more preferably the closed bottom comprises an infolded portion such as a gusset which when opened enables expansion of the bottom of the sleeve for allowing insertion of a pot therein.

One version of the apparatus and process used to construct a sleeve as described herein is shown in FIG. 34. A single web of material 130 from a roll 131 is fed by a drive element such as an electric motor (not shown) to a folding assembly 132 which causes the web of material 130 to fold and double up on itself to form a folded web of material 134 having an open side 136 and a folded side 138. The folded web of material 134 is supported upon a conveyor or other support surface 140. As the folded web of material 134 is advanced by drive rollers 141 or other advancing elements in a direction 142, the folded side 138 is caused in a continuous process to be infolded or pouched by an infolding device 144 forming a pouch 146 which extends the length of the folded web of material 134. The folded web of material 134 with the pouch 146 therein continues to be advanced in the direction 142 to a sealing position 148. A sealing bar (not shown) such as is common in the art is then activated forming a pair of sealed edges 150 and 152. The sealed edges 150 and 152 extend from the pouch 146 to the open side 136 and form a sealed bottom or gusset 154.

The folded web of material 134, now having a sleeve 160 outlined by the sealed edges 150 and 152, is further advanced to a perforating position 155 where perforations 156 are punched into the sleeve 160 and optionally support apertures 158 are also punched into the sleeve 160 for enabling a collection of sleeves 160 to be collected in a stack and held on a support mechanism such as a wicket (not shown). Ventilation holes may also be punched into the sleeve 160 at this point. In the next step the sleeve 160, now with sealed edges 150 and 152 and with perforations 156, is advanced to a cutting position 159 where the sleeve 160 is cut by a cutting die or blade (not shown), which is well known in the art, from the folded web of material 134 to form the completed sleeve 160. Excess material 162 may be removed to facilitate removal and storage of the sleeve 160. It will be understood by one of ordinary skill in the art that the steps of sealing, perforating and cutting the sleeves may be performed together in a single step, or two steps at one or two positions.

The process outlined above describes the construction of the sleeve 160 without a bonding material disposed upon any portion thereof. However, as explained above, in a preferred version of the invention, a bonding material 166 for bonding a portion of the sleeve 160 to a pot (not shown) is located on a portion of the inner surface 161 of the sleeve 160, said portion of the inner surface 161 being exposed. Also shown in FIG. 34 is a bonding material applicator 164 such as a sprayer or pad applicator which can be used to apply an area of bonding material 166 to a portion of the inner surface 166 of a sleeve 160. The bonding material applicator 164 may be reciprocatingly activated by a reciprocating assembly (not shown) which is preferably automatically controlled and construction of which is well within the level of ordinary skill in the art. The bonding material 166 is preferably applied to the web of material 130 prior to the doubling over of the web of material 130 so that when the web of material 130 is doubled over to form the folded web of material 134, the bonding material 166 is oriented on a portion of the inner surface 161 of the sleeve 160, preferably in a lower portion 163 of the sleeve 160. The result is the production of a sleeve like sleeve 10 in FIG. 2.

The process described herein can be modified to produce sleeves such as any of the other sleeves described elsewhere herein. For example, a sleeve such as sleeve 10a in FIG. 3 can be produced by inserting a piece of release material 52 into the sleeve 10a at some point during the sleeve production process, either manually or automatically, for example, after the bonding material 166 has been applied but before the web of material 130 has been folded over to form the folded web of material 134. The piece of release material 52 may be inserted manually by hand or automatically using a device which automatically shoots or blows or deposits such pieces of material and which is well within the skill of one of ordinary skill in the art. Alternatively, the release material 52 may be applied directly upon the bonding material 166 when the bonding material 166 is applied to the web of material 130, ultimately resulting in a sleeve such as sleeve 10b shown in FIG. 5. An additional area of bonding material may be applied to another portion of the web of material with another adhesive applicator (not shown) thereby forming sleeves such as the sleeves shown in FIGS. 6-10, 13, 14 and 16A-17C. The sleeves described herein can be produced in a production line wherein one or more webs are side welded to form waterproof seals (or any other appropriate weld method). Webs may be glued, folded, extruded, in side-to side, or in opposing directions, for example.

FIG. 34 shows both edges of open side 136 of the folded web of material 134 as being an equal distance from the folded side 138. It will be understood by one of ordinary skill in the art that the two edges which comprise the open side 136 of the folded web of material 134 can be offset during the folding process to form a sleeve such as sleeve 10m or 10n in FIGS. 17A and 17B having an upper end flap which can be folded over to close the upper end of the sleeve.

FIG. 34 shows a sleeve-forming process in which the web of material 130 is doubled over to form a folded web of material 134. The sleeve 160 formed as described herein may also be formed during a process using two or more separate webs of material as shown in FIG. 35. FIG. 35 shows a first roll of material 170 and a second roll of material 172 from which are unrolled a first web of material 174 and a second web of material 176, respectively. The first and second webs of material 174 and 176 are fed in a direction 178 to a position where one side (not shown) of the first and second webs of material 174 and 176 are sealed by a sealing assembly 180. If a gusset in the finished sleeve is desired, the sealed side can be infolded to form a pouched side as described in the process of FIG. 34. The remainder of the operation can be formed as described above for the process of FIG. 34.

Sleeves formed in accordance with the present invention can also be formed from tubular materials such as are commercially available. For example, a sleeve such as sleeve 10r in FIG. 20 can be formed by cutting a portion of a tube, forming a gusset in the lower end of the tube, or simply sealing the lower end of the tube to form a closed bottom, then sealing and cutting off portions of the lower end of the tube forming a sleeve having a tapered lower end. Adhesive may be applied to an interior portion of the sleeve by opening the tube and spraying a bonding material onto a portion of the inner surface of the sleeve, for example. In another version of the invention, the process of forming the tubular material from one or more flat webs of material may comprise a step in the process of forming a sleeve.

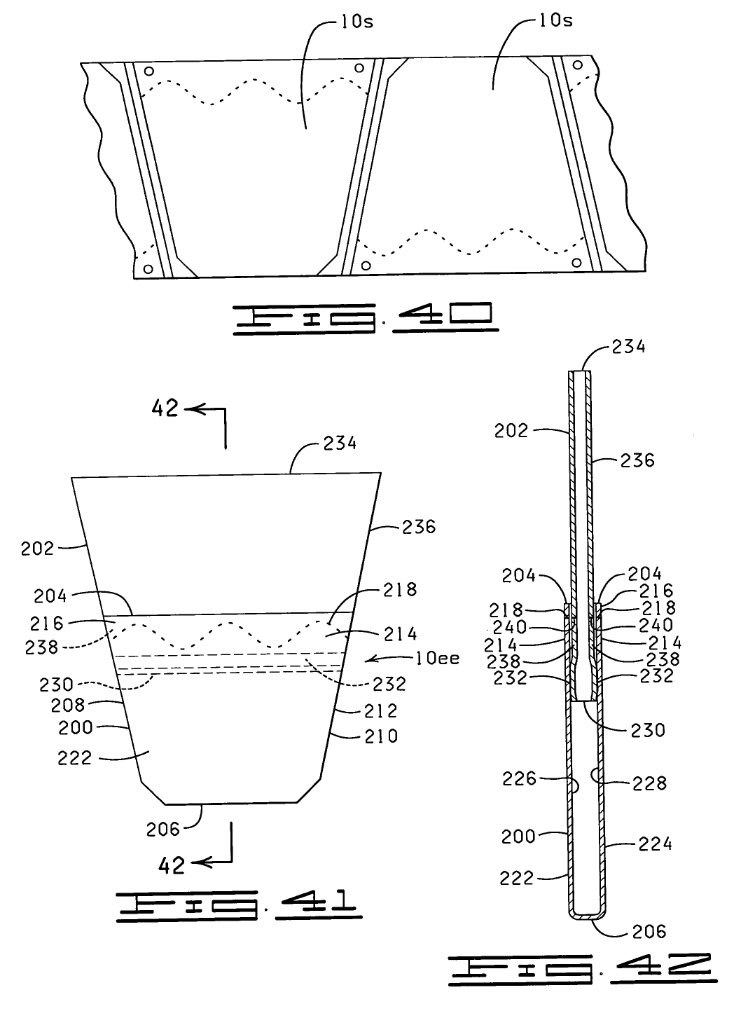

FIGS. 36-40 show other configurations of sleeves having sealed lower ends which can be formed. Shown in FIG. 36 is a process in which sides 184 and 186 of a folded web of material 134a are sealed and a plurality of sleeves 188 are formed in the folded web of material 134a and are positioned in an alternating upward and downward orientation to maximize usage of the web of material 130a. The sleeve 10aa formed in this method, when severed from the web of material 130a has an upper gusset 190 in an upper end 191 and a lower gusset 192 in the lower end 193 of the plurality of sleeves 188 and thus is initially closed at both the upper end 191 and the lower end 193. Therefore, after severing the sleeve 10aa from the web of material 130a, the upper gusset 190 of the sleeve 10aa must be cut away from the sleeve 10aa to form an open end (not shown) in the sleeve 10aa. This may be done, for example, after the plurality of sleeves 188 have been stacked to save time. FIG. 37 shows a sleeve 10bb having a different shape, formed in a manner similar to that for FIG. 36 wherein upper and lower gussets 190bb and 192bb, respectively are formed during the sleeve forming process. FIGS. 38 and 39 show sleeves 10cc and 10dd, respectively, which may be formed in accordance with the present invention, wherein lower ends 194 and 196, respectively, of the sleeves 10cc and 10dd shown in FIGS. 38 and 39 are heat sealed but not gusseted. FIG. 40 shows a process in which sleeve 10s, previously described, can be formed using one or more webs of material. This is an especially preferred embodiment of the manufacturing method since it facilitates the production of alternately oriented sleeves thereby reducing wastage of material (scrap) and reducing production time. It will be appreciated that any of the sleeves described in FIGS. 34-40 may comprise any of the sleeve embodiments discussed elsewhere herein. For example, perforations 200 are shown as being formed in sleeve 10dd.

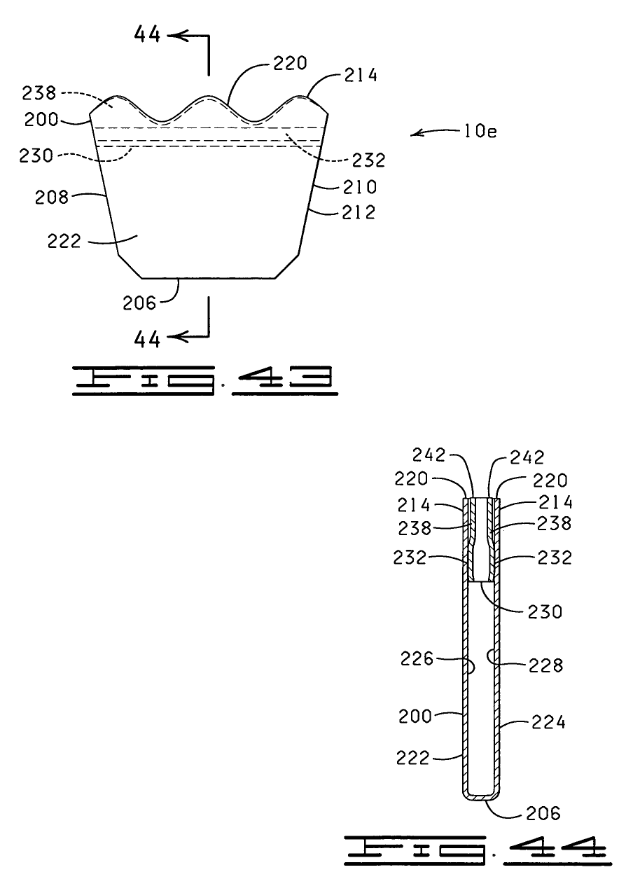

### Embodiments of FIGS. 41-44

FIGS. 41 and 42 show a sleeve 10ee which is constructed to initially have a flattened condition prior to being opened for deposition of a pot in a manner as described elsewhere herein.

Sleeve 10ee is generally similar to sleeve 10s in that it has a lower portion 200 which is designed to provide a decorative cover for a pot and an upper sleeve portion 202 which is designed to function as a protective sheath for a plant or floral grouping disposed within a pot (it will be understood by a person of ordinary skill in the art that a floral grouping and/or growth medium or retaining medium may be disposed within the sleeve 10ee without a pot). The lower portion 200 has an upper end 204, a lower end 206, a left edge 208, a right edge 210, a body 212, a skirt portion 214, and a detachable portion 216. The detachable portion 216 extends from the skirt portion 214 and is detachable therefrom via a detaching element 218. When the detachable portion 216 is detached from the skirt portion 214 via the detaching element 218, an upper peripheral edge 220 is left in the skirt portion 214 (FIGS. 43 and 44). The upper peripheral edge 220 may be non-linear or linear, as described elsewhere herein for the other floral sleeves described elsewhere herein. The detachable portion 216 may be absent in an alternative embodiment, wherein the upper peripheral edge 220 is present in the skirt portion 214 of the lower portion 200 when the sleeve 10ee is initially constructed.

The lower portion 200 further comprises a first outer surface 222, a second outer surface 224, a first inner surface 226 and a second inner surface 228. The upper sleeve portion 202 is attached near a lower end 230 thereof at an attached area 232 to a portion of the first inner surface 226 and a portion of the second inner surface 228, preferably at a position below the detaching element 218 in the lower portion 200. The upper sleeve portion 202 further comprises an upper end 234, an upper sleeve upper portion 236, an upper sleeve lower portion 238, and a sleeve detaching element 240 for separating the upper sleeve upper portion 236 from the upper sleeve lower portion 238. The sleeve detaching element 240 may be linear or non-linear as described elsewhere herein. Preferably the sleeve detaching element 240 is congruent with the detaching element 218 such that when the upper sleeve upper portion 236 is detached from the upper sleeve lower portion 238, a sleeve edge 242 is left in the upper sleeve lower portion 238 which corresponds to the upper peripheral edge 220 (FIGS. 43 and 44). In an alternate embodiment, the detaching element 218 may be incongruent with the sleeve detaching element 240 wherein the sleeve edge 242 does not correspond with the upper peripheral edge 220 of the skirt portion 214. For example, the upper peripheral edge 220 may be above or below the sleeve edge 242. In yet another embodiment of the sleeve 10ee, the upper sleeve portion 202 may be connected to portions of the first outer surface 222 and the second outer surface 224 instead of the first inner surface 226 and second inner surface 228. The upper sleeve portion 202 is preferably constructed of a material which is different from the material used to construct the lower portion 200. For example, the material used to construct the upper sleeve portion 202 is in one embodiment a clear, non-tinted or tinted, printed or non-printed, transparent polymeric film, while the lower portion 200 is constructed of a tinted and/or printed or colored opaque or translucent polymeric film.

Changes may be made in the construction and the operation of the various components, elements and assemblies described herein or in the steps or the sequence of steps of the methods described herein without departing from the spirit and scope of the invention as defined in the following claims.

What is claimed is:

1. A method of covering a pot, comprising:
providing a floral sleeve for containing a pot, comprising:
a body having a substantially flattened condition and having a first panel, a second panel, an open upper end, a closed lower end having a bottom edge, a left side edge, a right side edge, and an inner retaining space, the body further comprising a lower portion and an upper portion which is detachable from the lower portion via a detaching element and the lower portion comprising a skirt portion which is left with an upper edge when the upper portion is detached from the lower portion, the upper edge having an angular non-linear pattern, and wherein the left side edge and the right side edge are angled inwardly near the lower end to form a half hexagonal shape in the lower end of the body when the body is in the substantially flattened condition, the body absent a gusset in the lower end when the body is in the substantially flattened condition and wherein a distance between the left side edge and the right side edge near the half hexagonal shape in the lower end is less than a distance between the left side edge and the right side edge near the upper end; and
disposing a pot into the floral sleeve, wherein the upper end of the floral sleeve remains at least partially open.

2. The method of claim 1 wherein in the step of providing the floral sleeve, the upper portion is adapted to be supported on a support device or in a pad.

3. The method of claim 1 wherein in the step of providing the floral sleeve, the upper portion is sized to surround and enclose a floral grouping disposed within the pot contained within the floral sleeve.

4. The method of claim 1 wherein in the step of providing the floral sleeve, the detaching element is a line of perforations.

5. The method of claim 1 further comprising securing the floral sleeve about the pot via a securing element.

6. The method of claim 1 wherein at least a portion of the lower portion of the floral sleeve is tapered between the half hexagonal shape in the lower end and the detaching element which is between the upper portion and the lower portion of the floral sleeve.

7. The method of claim 1 wherein when the floral sleeve is in an opened condition and the pot is disposed within the floral sleeve, the floral sleeve has a bottom having a first folded portion and a second folded portion, wherein the first folded portion and the second folded portion are substantially concealed underneath the pot.

8. The method of claim 1 wherein the bottom edge of the lower end comprises a straight seal between the left side edge and the right side edge.

9. A method of covering a pot;
providing a floral sleeve for containing a pot, comprising:
a body having a substantially flattened condition and having a first panel, a second panel, an open upper end, a closed lower end having a bottom edge, a left side edge, a right side edge, and an inner retaining space, the body further comprising a lower portion and an upper portion which is detachable from the lower portion via a detaching element and the lower portion comprising a skirt portion which is left with an upper edge when the upper portion is detached from the lower portion, the upper edge having a curved non-linear pattern, and wherein the left side edge and the right side edge are angled inwardly near the lower end to form a half hexagonal shape in the lower end of the body when the body is in the substantially flattened condition, the body absent a gusset in the lower end when the body is in the substantially flattened condition and wherein a distance between the left side edge and the right side edge near the half hexagonal shape in the lower end is less than a distance between the left side edge and the right side edge near the upper end; and
disposing a pot into the floral sleeve, wherein the upper end of the sleeve remains at least partially open.

10. The method of claim 9 wherein in the step of providing the floral sleeve, the upper portion is adapted to be supported by a support device, or in a pad.

11. The method of claim 9 wherein in the step of providing the floral sleeve, the upper portion is sized to surround and enclose a floral grouping disposed within the pot contained within the floral sleeve.

12. The method of claim 9 wherein in the step of providing the floral sleeve, the detaching element is a line of perforations.

13. The method of claim 9 further comprising securing the floral sleeve about the pot via a securing element.

14. The method of claim 9 wherein at least a portion of the lower portion of the floral sleeve is tapered between the half hexagonal shape in the lower end and the detaching element which is between the upper portion and the lower portion of the floral sleeve.

15. The method of claim 9 wherein when the floral sleeve is in an opened condition and the pot is disposed within the floral sleeve, the floral sleeve has a bottom having a first folded portion and a second folded portion, wherein the first folded portion and the second folded portion are substantially concealed underneath the pot.

16. The method of claim 9 wherein the bottom edge of the lower end comprises a straight seal between the left side edge and the right side edge.

17. A method of providing a decorative wrapper for a potted plant and/or floral grouping comprising:
providing a floral sleeve comprising:
a body having a substantially flattened condition and having a first panel, a second panel, an open upper end, a closed lower end having a bottom edge, a left side edge, a right side edge, and an inner retaining space, the body further comprising a lower portion and an upper portion which is detachable from the lower portion via a detaching element and the lower portion comprising a skirt portion which is left with an upper edge when the upper portion is detached from the lower portion, the upper edge having an angular non-linear pattern, and wherein the left side edge and the right side edge are angled inwardly near the lower end to form a half hexagonal shape in the lower end of the body when the body is in the substantially flattened condition, the body absent a gusset in the lower end when the body is in the substantially flattened condition and wherein a distance between the left side edge and the right side edge near the half hexagonal shape in the lower end is less than a distance between the left side edge and the right side edge near the upper end, and wherein the upper end of the sleeve remains at least partially open when a potted plant and/or floral grouping is disposed therein; and
selling and delivering the floral sleeve to a producer or seller of potted plants for producing a decoratively covered potted plant and/or floral grouping by the producer or seller.

18. The method of claim 17 wherein when the potted plant and/or floral grouping is disposed within the opened floral sleeve, the floral sleeve is secured about the potted plant and/or floral grouping via a securing element.

19. The method of claim 17 wherein in the step of providing a floral sleeve at least a portion of the lower portion of the floral sleeve is tapered between the half hexagonal shape in the lower end and the detaching element which is between the upper portion and the lower portion of the floral sleeve.

20. The method of claim 17 wherein in the step of providing a floral sleeve when the floral sleeve is in an opened condition and the potted plant and/or floral grouping is disposed within the floral sleeve, the floral sleeve has a bottom having a first folded portion and a second folded portion, wherein the first folded portion and the second folded portion are substantially concealed underneath the pot.

21. The method of claim 17 wherein in the step of providing a floral sleeve the bottom edge of the lower end comprises a straight seal between the left side edge and the right side edge.

22. A method of providing a decorative wrapper for a potted plant and/or floral grouping comprising:
providing a floral sleeve comprising;
a body having a substantially flattened condition and having a first panel, a second panel, an open upper end, a closed lower end having a bottom edge, a left side edge, a right side edge, and an inner retaining space, the body further comprising a lower portion and an upper portion which is detachable from the lower portion via a detaching element and the lower portion comprising a skirt portion which is left with an upper edge when the upper portion is detached from the lower portion, the upper edge having a curved non-linear pattern, and wherein the left side edge and the right side edge are angled inwardly near the lower end to form a half hexagonal shape in the lower end of the body when the body is in the substantially flattened condition, the body absent a gusset in the lower end when the body is in the substantially flattened condition and wherein a distance between the left side edge and the right side edge near the half hexagonal shape in the lower end is less than a distance between the left side edge and the right side edge near the upper end, and wherein the upper end of the sleeve remains at least partially open when a potted plant and/or floral grouping is disposed therein; and
selling and delivering the floral sleeve to a producer or seller of potted plants for producing a decoratively covered potted plant and/or floral grouping by the producer or seller.

23. The method of claim 22 wherein when the potted plant and/or floral grouping is disposed within the opened floral sleeve, the floral sleeve is secured about the potted plant and/or floral grouping via a securing element.

24. The method of claim 22 wherein in the step of providing a floral sleeve at least a portion of the lower portion of the floral sleeve is tapered between the half hexagonal shape in the lower end and the detaching element which is between the upper portion and the lower portion of the floral sleeve.

25. The method of claim 22 wherein in the step of providing a floral sleeve when the floral sleeve is in an opened condition and the potted plant and/or floral grouping is disposed within the floral sleeve, the floral sleeve has a bottom having a first folded portion and a second folded portion, wherein the first folded portion and the second folded portion are substantially concealed underneath the pot.

26. The method of claim 22 wherein in the step of providing a floral sleeve the bottom edge of the lower end comprises a straight seal between the left side edge and the right side edge.
